(19) United States
(12) Patent Application Publication
(10) Pub. No.: US 2007/0115319 A1
(43) Pub. Date: May 24, 2007

(54) Image forming apparatus, maintenance-recovery mechanism, and suction pump

(76) Inventor: Kazumasa Ishikawa, Kawasaki City (JP)

Correspondence Address: COOPER & DUNHAM, LLP, 1185 AVENUE OF THE AMERICAS, NEW YORK, NY, 10036, US

(21) Appl. No.: 11/603,792

(22) Filed: Nov. 22, 2006

(30) Foreign Application Priority Data
Nov. 24, 2005 (JP) 2005-338368

(51) Int. Cl. B41J 2/165

(52) U.S. Cl. 347/33

(57) ABSTRACT

An image forming apparatus includes a maintenance-recovery mechanism including a suction pump. The suction pump includes a tube, a housing, a pressing member, a rotating member, and a regulating member. The tube channels a liquid drawn from. a recording head through one end of the tube by the suction pump and discharges the liquid at another end of the tube. The housing includes an inner wall holding the tube along the inner wall. The rotating member includes a groove engaged with a shaft of the pressing member to guide the pressing member between a first position at which the pressing member presses the tube towards the inner wall of the housing while the pressing member moves along the tube and a second position at which the pressing member does not press the tube. The regulating member coaxially rotates with the rotating member to regulate movement of the pressing member in a circumferential direction.

### TECHNICAL FIELD

The present specification describes an image forming apparatus, a maintenance-recovery mechanism, and a suction pump, and more particularly an image forming apparatus, a maintenance-recovery mechanism, and a suction pump for sucking a liquid from a recording head of the image forming apparatus.

### DISCUSSION OF THE BACKGROUND

An image forming apparatus, such as a copying machine, a printer, a facsimile machine, or a multifunction printer including copying, printing, scanning, and facsimile functions, forms an image on a recording medium (e.g., a sheet) according to image data with an ink. The ink is discharged from a nozzle of a recording head. While the recording head moves in a main scanning direction, the recording head discharges the ink onto the sheet to form an image. After the ink is discharged from the nozzle of the recording head, a recording head maintenance mechanism, which is provided in a non-printing area where the recording head does not discharge the ink, wipes the nozzle of the recording head and sucks residue ink having an increased viscosity from the nozzle to prevent the nozzle from being clogged with the ink.

FIGS. 1A and 1B illustrate a suction pump 10r of a recording head maintenance mechanism included in one example of a related art image forming apparatus. The suction pump 10r applies suction to draw an ink from a nozzle of a recording head (not shown). FIG. 1A is a perspective plane view of the suction pump 10r during a pumping operation. FIG. 1B is a perspective plane view of the suction pump 10r during a non-pumping operation. As illustrated in FIGS. 1A and 1B, the suction pump 10r includes a central shaft 11r , a rear plate 12r, a front plate 13r, pressing rollers 15ra and 15rb, pressing roller shafts 14ra and 14rb, grooves 16ra and 16rb, guides 17ra and 17rb, engaging ends 18ra and 18rb, engaging ends 19ra and 19rb, a housing 21r, and a tube 20r.

The central shaft 11r supports the rear plate 12r and the front plate 13r. The pressing rollers 15ra and 15rb are provided between the rear plate 12r and the front plate 13r. The pressing roller shafts 14ra and 14rb support the pressing rollers 15ra and 15rb, respectively. The pressing roller shafts 14ra and 14rb movably engage with the grooves 16ra and 16rb, respectively. When a motor (not shown) rotates the rear plate 12r and the front plate 13r in a rotating direction R (depicted in FIG. 1A), the pressing roller shaft 14ra of the pressing roller 15ra moves towards the engaging end 18ra along the groove 16ra provided on the rear plate 12r and along the guide 17ra provided on the front plate 13r. The pressing roller shaft 14rb of the pressing roller 15rb moves towards the engaging end 18rb along the groove 16rb provided on the rear plate 12r and along the guide 17rb provided on the front plate 13r. Thus, the pressing roller shafts 14ra and 14rb contact the engaging ends 18ra and 18rb provided on one end of the guides 17ra and 17rb, respectively, as illustrated in FIG. 1A. The engaging ends 19ra and 19rb are provided on another end of the guides 17ra and 17rb, respectively. A distance S from the center of the central shaft 11r to the engaging end 18ra is greater than a distance T from the center of the central shaft 11r to the engaging end 19ra. Similarly, a distance from the center of the central shaft 11r to the engaging end 18rb is greater than a distance from the center of the central shaft 11r to the engaging end 19rb.

The housing 21r includes a concave portion (not shown) which engages with the tube 20r. The tube 20r is set in the concave portion of the housing 21r and conveys an ink. One end of the tube 20r is connected to a head cap (not shown) which caps the nozzle of the recording head to suck ink from the nozzle. Another end of the tube 20r is connected to a collected ink container (not shown). When the rear plate 12r and the front plate 13r further rotate in the rotating direction R while the pressing roller shafts 14ra and 14rb contact the engaging ends 18ra and 18rb, respectively, the pressing rollers 15ra and 15rb alternately press the tube 20r towards the concave portion of the housing 21r while the pressing rollers 15ra and 15rb move along the tube 20r. Namely, the pressing rollers 15ra and 15rb apply a positive pressure to the tube 20r. When the rear plate 12r and the front plate 13r further rotate in the rotating direction R, the pressing rollers 15ra and 15rb alternately move away from the tube 20r and the pressure applied to the tube 20r is released. Namely, the pressing rollers 15ra and 15rb apply a negative pressure to the tube 20r. Thus, a pumping operation is performed and ink is sucked into the tube 20r. To stop the pumping operation, the rear plate 12r and the front plate 13r rotate in a rotating direction U depicted in FIG. 1B (i.e., a direction opposite to the rotating direction R depicted in FIG. 1A) so as to move the pressing roller shafts 14ra and 14rb towards the engaging ends 19ra and 19rb along the grooves 16ra and 16rb and along the guides 17ra and 17rb, respectively. Thus, the pressing roller shafts 14ra and 14rb contact the engaging ends 19ra and 19rb, respectively, and thereby the pressing rollers 15a and 15b do not contact the tube 20r while the pressing rollers 15a and 15b move along the tube 20r. Namely, the pressing rollers 15ra and 15rb do not apply a pressure to the tube 20r. Thus, a pumping operation is not performed.

When the dimension tolerance between the dimension of the pressing rollers 15ra and 15rb and the dimension of the housing 21r is not controlled to be within a predetermined range, the pressing rollers 15ra and 15rb do not move properly. For example, when the rear plate 12r and the front plate 13r rotate in the rotating direction R (depicted in FIG. 1A), the pressing rollers 15ra and 15rb may move to the engaging ends 19ra and 19rb, respectively. As a result, the pressing rollers 15ra and 15rb may not press the tube 20r. When the rear plate 12r and the front plate 13r rotate in the rotating direction U (depicted in FIG. 1B), the pressing rollers 15ra and 15rb may not move to the engaging ends 19ra and 19rb, respectively. As a result, the pressing rollers 15ra and 15rb may press the tube 20r. Further, when the pressing rollers 15ra and 15rb alternately move away from the engaging ends 18ra and 18rb, respectively, an elastic force of the tube 20r may bounce the pressing rollers 15ra and 15rb and an impulsive sound may be generated when the bounced pressing rollers 15ra and 15rb hit the grooves 16ra and 16rb, respectively.

### SUMMARY

This patent specification describes a novel image forming apparatus. One example of a novel image forming apparatus includes a recording head configured to discharge a liquid onto a recording medium and a maintenance-recovery mechanism configured to maintain and recover the recording head. The maintenance-recovery mechanism includes a cap configured to cap the recording head and a suction pump configured to suck a liquid from the recording head through the cap. The suction pump includes a tube, a housing, a pressing member, a rotating member, and a regulating member. The tube is connected at one end of the tube to the cap, and channels the liquid drawn through the cap and the one end of the tube by the suction pump and discharges the liquid at another end of the tube. The housing includes an inner wall having an arc-like shape, the inner wall holding the tube along the inner wall. The pressing member is configured to move along the tube and includes a shaft provided at a center of the pressing member. The rotating member is configured to rotate to move the pressing member and includes a groove engaged with the shaft of the pressing member to guide the pressing member between a first position at which the pressing member presses the tube towards the inner wall of the housing while the pressing member moves along the tube and a second position at which the pressing member does not press the tube. The regulating member is configured to coaxially rotate with the rotating member to regulate movement of the pressing member in a circumferential direction.

This patent specification further describes a novel maintenance-recovery mechanism for maintaining and recovering a recording head of an image forming apparatus. One example of a novel maintenance-recovery mechanism includes a cap configured to cap the recording head and a suction pump configured to suck a liquid from the recording head through the cap. The suction pump includes a tube, a housing, a pressing member, a rotating member, and a regulating member. The tube is connected at one end of the tube to the cap, and channels the liquid drawn through the cap and the one end of the tube by the suction pump and discharges the liquid at another end of the tube. The housing includes an inner wall having an arc-like shape, the inner wall holding the tube along the inner wall. The pressing member is configured to move along the tube and includes a shaft provided at a center of the pressing member. The rotating member is configured to rotate to move the pressing member and includes a groove engaged with the shaft of the pressing member to guide the pressing member between a first position at which the pressing member presses the tube towards the inner wall of the housing while the pressing member moves along the tube and a second position at which the pressing member does not press the tube. The regulating member is configured to coaxially rotate with the rotating member to regulate movement of the pressing member in a circumferential direction.

This patent specification further describes a novel suction pump for sucking a liquid from a recording head of an image forming apparatus. One example of a novel suction pump includes a tube, a housing, a pressing member, a rotating member, and a regulating member. The tube is connected at one end of the tube to the recording head, and channels the liquid drawn through the one end of the tube by the suction pump and discharges the liquid at another end of the tube. The housing includes an inner wall having an arc-like shape, the inner wall holding the tube along the inner wall. The pressing member is configured to move along the tube and includes a shaft provided at a center of the pressing member. The rotating member is configured to rotate to move the pressing member and includes a groove engaged with the shaft of the pressing member to guide the pressing member between a first position at which the pressing member presses the tube towards the inner wall of the housing while the pressing member moves along the tube and a second position at which the pressing member does not press the tube. The regulating member is configured to coaxially rotate with the rotating member to regulate movement of the pressing member in a circumferential direction.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A is a perspective plane view of a suction pump during a pumping operation;

FIG. 1B is a perspective plane view of a suction pump during a non-pumping operation;

FIG. 2 is a schematic view of an image forming apparatus according to an exemplary embodiment;

FIG. 3 is a top view of an image forming unit and a bypass sheet supplier included in the image forming apparatus shown in FIG. 2;

FIG. 4A is a perspective plane view of a suction pump included in the image forming unit shown in FIG. 3 during a pumping operation;

FIG. 4B is a perspective plane view of a suction pump included in the image forming unit shown in FIG. 3 during a non-pumping operation;

FIG. 5A is a plane view of a rear plate included in the suction pump shown in FIGS. 4A and 4B;

FIG. 5B is a plane view of a front plate included in the suction pump shown in FIGS. 4A and 4B;

FIG. 5C is a plane view of a regulating plate included in the suction pump shown in FIGS. 4A and 4B;

FIG. 6A is a perspective plane view of a suction pump included in the image forming unit shown in FIG. 3 during a pumping operation according to another exemplary embodiment;

FIG. 6B is a perspective plane view of a suction pump included in the image forming unit shown in FIG. 3 during a non-pumping operation according to another exemplary embodiment;

FIG. 7 is a perspective plane view of a suction pump included in the image forming unit shown in FIG. 3 according to yet another exemplary embodiment;

FIG. 8 is a perspective plane view of a suction pump included in the image forming unit shown in FIG. 3 according to yet another exemplary embodiment;

FIG. 9 is a perspective plane view of a suction pump included in the image forming unit shown in FIG. 3 according to yet another exemplary embodiment;

FIG. 10 is a sectional side view of a suction pump included in the image forming unit shown in FIG. 3 according to yet another exemplary embodiment;

FIG. 11 is a sectional side view of a suction pump included in the image forming unit shown in FIG. 3 according to yet another exemplary embodiment;

FIG. 12 is a sectional side view of a suction pump included in the image forming unit shown in FIG. 3 according to yet another exemplary embodiment;

FIG. 13 is a sectional side view of a suction pump included in the image forming unit shown in FIG. 3 according to yet another exemplary embodiment;

FIG. 14 is a sectional side view of a suction pump included in the image forming unit shown in FIG. 3 according to yet another exemplary embodiment;

FIG. 15 is a perspective plane view of a suction pump included in the image forming unit shown in FIG. 3 according to yet another exemplary embodiment; and

FIG. 16 is a perspective plane view of a suction pump included in the image forming unit shown in FIG. 3 according to yet another exemplary embodiment.

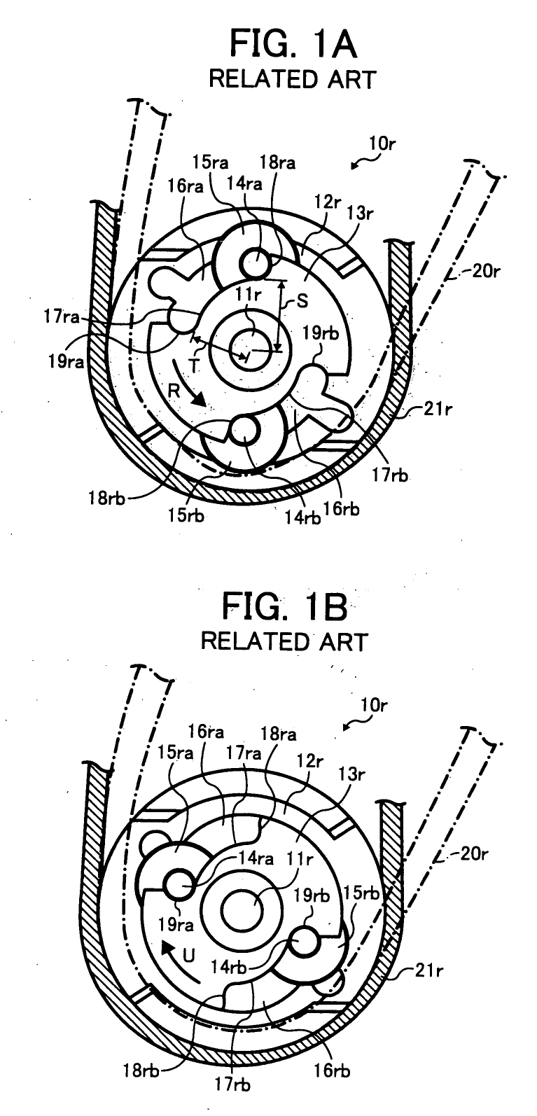

### DETAILED DESCRIPTION OF THE EXEMPLARY EMBODIMENTS

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

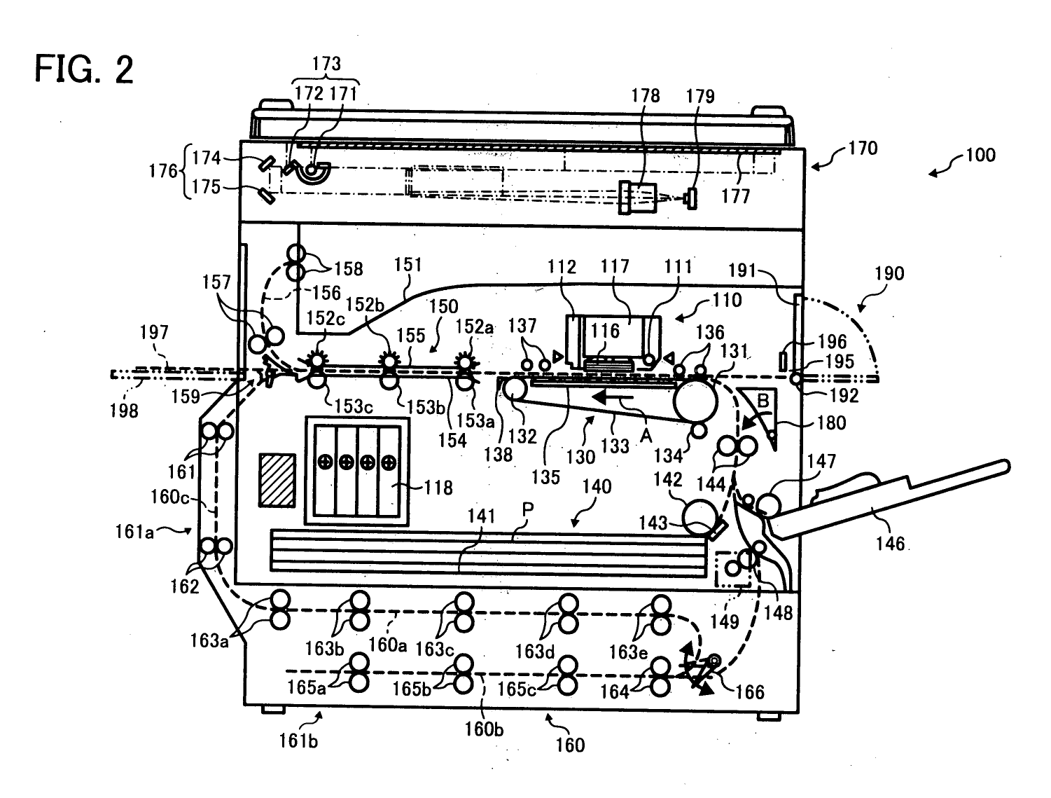

Referring now to the drawings, wherein like reference numerals designate identical or corresponding parts throughout the several views, in particular to FIG. 2, an image forming apparatus 100 according to an exemplary embodiment is explained.

FIG. 2 is a schematic view of the image forming apparatus 100. As illustrated in FIG. 2, the image forming apparatus 100 includes a reader 170, an image forming unit 110, a paper tray unit 140, a sub-scanning direction conveyer 130, an output conveyer 150, a duplex unit 160, a guide 180, a bypass sheet supplier 190, and ink cartridges 118.

The image forming apparatus 100 may be a copying machine, a printer, a facsimile machine, and a multifunction printer including copying, printing, scanning, and facsimile functions. In this non-limiting exemplary embodiment, the image forming apparatus 100 functions as a color copying machine for forming a color image on a recording medium.

The reader 170 is disposed in an upper portion of the image forming apparatus 100 and above the output conveyer 150. The reader 170 scans an image on an original sheet to generate image data. The image forming unit 110 forms an image on a recording medium according to the image data generated by the reader 170. The paper tray unit 140 is attachable to and detachable from the front of the image forming apparatus 100 and loads a recording medium (e.g., sheets P). The sub-scanning direction conveyer 130 turns a direction in which a sheet P fed from the paper tray unit 140 is conveyed by about 90 degrees so that the sheet P opposes the image forming unit 110, and conveys the sheet P towards the output conveyer 150. The output conveyer 150 outputs the sheet P or conveys the sheet P to the duplex unit 160. The duplex unit 160 reverses the sheet P fed from the output conveyer 150 and feeds the sheet P towards the image forming unit 110 so that an image is formed on the other side of the sheet P. The guide 180 is disposed between the paper tray unit 140 and the sub-scanning direction conveyer 130 in a sheet conveyance direction and swings to slack the sheet P fed from the paper tray unit 140 or the. duplex unit 160. The bypass sheet supplier 190 loads a sheet P such as thick paper and an OHP (overhead projector) transparency. The ink cartridges 118 are attachable to and detachable from the front of the image forming apparatus 100 and contain black, cyan, magenta, and yellow inks, respectively.

The reader 170 includes an exposure glass 177, optical scanning systems 173 and 176, a lens 178, and a scanning element 179. The optical scanning system 173 includes a light source 171 and a mirror 172. The optical scanning system 176 includes mirrors 174 and 175.

An original sheet bearing an image is placed on the exposure glass 177 facing down. The optical scanning systems 173 and 176 move to scan the image on the original sheet. The light source 171 emits light onto the original sheet placed on the exposure glass 177. The mirror 172 deflects the light reflected by the original sheet towards the mirror 174. The mirror 174 further deflects the light deflected by the mirror 172 towards the mirror 175. The mirror 175 further deflects the light deflected by the mirror 174 towards the lens 178. The lens 178 emits the light deflected by the mirror 175 towards the scanning element 179. The scanning element 179 converts the light into an image signal. The image signal is digitized and processed to generate image data.

The image forming apparatus 100 can also receive image data sent from an information processing device (e.g., a personal computer), an image scanning device (e.g., an image scanner), or a capturing device (e.g., a digital camera) via a cable or a network. The image forming apparatus 100 processes the received image data to form an image according to the processed image data.

The image forming unit 110 includes a guide rod 111, a carriage 112, recording heads 116, and sub tanks 117. The guide rod 111 supports the carriage 112 together with a stay (not shown) in a manner that the carriage 112 can move in a main scanning direction. The carriage 112 carries the recording heads 116. The recording heads 116 discharge liquid drops onto a sheet P sent from the paper tray unit 140 or the bypass tray supplier 190 according to the image data generated by the reader 170. The sub tanks 117 are mounted on the carriage 112 and contain inks to be supplied to the recording heads 116.

The paper tray unit 140 includes a paper tray 141, a feeding roller 142, a friction pad 143, a bypass tray 146, a bypass tray roller 147, a conveying roller 148, a feeding motor 149, and a registration roller pair 144. The paper tray 141 loads sheets P. The feeding roller 142 and the friction pad 143 feed the sheets P from the paper tray 141 one by one towards the registration roller pair 144. The bypass tray 146 loads sheets P. The bypass tray roller 147 feeds the sheets P from the bypass tray 146 one by one towards the registration roller pair 144. The conveying roller 148 feeds a sheet P fed from another paper tray (not shown), which can be optionally attached to a lower portion of the image forming apparatus 100, or the duplex unit 160 towards the registration roller pair 144. The feeding motor 149 includes an HB (hybrid) type stepping motor and rotatably drives the rollers for feeding the sheet P towards the sub-scanning direction conveyer 130, such as the feeding roller 142, the registration roller pair 144, the bypass tray roller 147, and the conveying roller 148, via an electromagnetic clutch (not shown). The registration roller pair 144 temporarily stops feeding the sheet P fed by the feeding roller 142, the bypass tray roller 147, or the conveying roller 148.

The sub-scanning direction conveyer 130 includes a conveying belt 133, a conveying roller 131, a tension roller 132, a charging roller 134, a guide 135, two pressing rollers 136, two spur rollers 137, and a separating nail 138.

The conveying belt 133 has an endless belt-like shape and is looped over the conveying roller 131 and the tension roller 132. The conveying roller 131, serving as a driving roller, rotates the conveying belt 133. The rotating conveying belt 133 rotates the tension roller 132. A high voltage power source (not shown) applies a high, alternating voltage to the charging roller 134, so that the charging roller 134 charges a surface of the conveying belt 133. The guide 135 opposes the image forming unit 110 and guides the rotating conveying belt 133. The pressing rollers 136 oppose the conveying roller 131 via the conveying belt 133 and press the sheet P conveyed on the conveying belt 133 towards the conveying belt 133. The spur rollers 137 press the sheet P bearing an image formed by the image forming unit 110 and conveyed on the conveying belt 133 towards the conveying belt 133. The separating nail 138 separates the sheet P bearing the image from the conveying belt 133.

A sub-scanning direction motor (not shown) rotatably drives the conveying roller 131 via a timing belt (not shown) and a timing roller (not shown) so that the rotating conveying roller 131 rotates the conveying belt 133 in a rotating direction A. The conveying belt 133 includes two layers, that is, a front layer which attracts the sheet P and a back layer which forms a medium resistive layer or a grounded layer. The front layer includes a resin material for which resistance control is not performed [e.g., an ETFE (ethylene tetrafluororethylene) material]. The back layer includes a material common to the front layer, for which resistance control is performed by using a carbon. However, the conveying belt 133 may include one layer or three or more layers.

The sub-scanning direction conveyer 130 further includes a cleaner (not shown) and a discharging brush (not shown). The cleaner is disposed between the tension roller 132 and the charging roller 134 in the rotating direction A and removes paper dust or the like adhered to the surface of the conveying belt 133. The discharging brush discharges the surface of the conveying belt 133.

The sub-scanning direction conveyer 130 further includes a rotary coder (not shown). The rotary coder includes a high-resolution code hole (not shown) and a transmission photo sensor (not shown). The high-resolution code hole is attached to a shaft (not shown) of the conveying roller 131. The transmission photo sensor detects a slit (not shown) formed in the high-resolution code hole.

The sub-scanning direction conveyer 130 further includes a linear encoder (not shown) and a joint sensor (not shown). The linear encoder includes a linear scale (not shown) and a reflection photo sensor (not shown). The linear scale is formed on an inner circumferential surface of the conveying belt 133, which contacts an outer circumferential surface of the conveying roller 131. The reflection photo sensor detects the linear scale. The linear scale can be formed in a stripe pattern by evaporating aluminum onto the inner circumferential surface of the conveying belt 133 and then irradiating a laser beam. The linear scale is disposed on a portion of the inner circumferential surface of the conveying belt 133 where the guide 135 may not disturb the detection by the reflection photo sensor. The joint sensor is adjacent to the reflection photo sensor and detects a joint of the linear scale provided on the inner circumferential surface of the conveying belt 133.

The output conveyer 150 includes three conveying rollers 153a, 153b, and 153c, three spur rollers 152a, 152b, and 152c, a lower guide 154, an upper guide 155, a first output path 156, a reverse roller pair 157, an output roller pair 158, an output tray 151, a second output path 197, a straight output tray 198, and a switching mechanism 159.

The conveying rollers 153a, 153b, and 153c convey the sheet P separated from the conveying belt 133 by the separating nail 138 towards the switching mechanism 159. The spur rollers 152a, 152b, and 152c oppose the conveying rollers 153a, 153b, and 153c, respectively, and convey the sheet P towards the switching mechanism 159. The lower guide 154 and the upper guide 155 guide the sheet P nipped and conveyed by the conveying rollers 153a, 153b, and 153c and the spur rollers 152a, 152b, and 152c. The first output path 156 is provided on a downstream side from the switching mechanism 159 relative to the sheet conveyance direction. The first output path 156 leads the sheet P to the output tray 151 so that the sheet P is reversed and output onto the output tray 151 facing down. The reverse roller pair 157 and the output roller pair 158 are disposed on the first output path 156 and feed the sheet P towards the output tray 151. The output tray 151 receives the sheet P fed by the output roller pair 158. The second output path 197 is provided on a downstream side from the switching mechanism 159 relative to the sheet conveyance direction. The second output path 197 leads the sheet P to the straight output tray 198. The straight output tray 198 receives the sheet P fed by the conveying roller 153c and the spur roller 152c. The switching mechanism 159 moves to guide the sheet P towards the first output path 156, the second output path 197, or the duplex unit 160.

The duplex unit 160 includes a vertical conveyer 161a and a horizontal conveyer 161b. The vertical conveyer 161a includes a vertical path 160c. The horizontal conveyer 161b includes a horizontal path 160a, a switchback path 160b, and a switching board 166. The vertical path 160c includes an entrance roller pair 161 and a conveying roller pair 162. The horizontal path 160a includes five conveying roller pairs 163a, 163b, 163c, 163d, and 163e. The switchback path 160b includes three conveying roller pairs 165a, 165b, and 165c and an exit roller pair 164.

The vertical conveyer 161a conveys the sheet P guided by the switching mechanism 159 towards the horizontal conveyer 161b. The horizontal conveyer 161b conveys the sheet P conveyed from the vertical conveyer 161a towards the conveying roller 148. The vertical path 160c leads the sheet P downward towards the horizontal path 160a. The horizontal path 160a leads the sheet P towards the switchback path 160b. The switchback path 160b switches back the sheet P and leads the sheet P towards the conveying roller 148. The switching board 166 swings to switch between a position illustrated in the solid line and a position illustrated in the broken line. When the switching board 166 is positioned at the position illustrated in the solid line, the sheet P is fed from the horizontal path 160a towards the switchback path 160b. When the switching board 166 is positioned at the position illustrated in the broken line, the sheet P is fed from the switchback path 160b towards the conveying roller 148.

The entrance roller pair 161 feeds the sheet P guided by the switching mechanism 159 downward to the conveying roller pair 162. The conveying roller pair 162 further feeds the sheet P towards the conveying roller pair 163a. The conveying roller pairs 163a, 163b, 163c, 163d, and 163e feed the sheet P towards the exit roller pair 164. The exit roller pair 164 feeds the sheet P towards the conveying roller pairs 165c, 165b, and 165a. The exit roller pair 164 and the conveying roller pairs 165c, 165b, and 165a also serve as reverse rollers. The conveying roller pairs 165c, 165b, and 165a feed the sheet P towards the exit roller pair 164. The exit roller pair 164 feeds the sheet P towards the conveying roller 148. The conveying roller 148 feeds the sheet P towards the registration roller pair 144.

The sheet P fed from the paper tray 141, the bypass tray 146, or the duplex unit 160 is further fed by the registration roller pair 144 towards the sub-scanning direction conveyer 130. When the sheet P is nipped by the registration roller pair 144 and by the conveying belt 133 and the pressing roller 136, the guide 180 swings in a direction B to slack the sheet P so as to prevent the sheet P from being tensioned backward.

When the registration roller pair 144 feeds the sheet P towards the sub-scanning direction conveyer 130, the guide 180 swings in the direction B to slack the sheet P and guides the sheet P towards the sub-scanning direction conveyer 130. When the sheet P reaches the sub-scanning direction conveyer 130, the guide 180 swings back to the original position to become ready for slacking the next sheet P.

The bypass sheet supplier 190 includes a bypass tray 191, a shaft 192, an opening 195, and a shutter 196. The bypass tray 191 is openable from and closable to one side of the image forming apparatus 100. To insert a sheet P into the bypass tray 191, the bypass tray 191 is opened to an open position illustrated in the chain double-dashed line. The shaft 192 supports the bypass tray 191 in a manner that the bypass tray 191 is openable from and closable to the image forming apparatus 100. The opening 195 is disposed on a downstream side from the bypass tray 191 relative to the sheet conveyance direction and is opened and closed by the shutter 196. The shutter 196 is disposed on an upstream side from the sub-scanning direction conveyer 130 relative to the sheet conveyance direction. The shutter 196 closes to regulate the sheet P inserted into the bypass tray 191 in a sub-scanning direction and opens to send the sheet P towards the sub-scanning direction conveyer 130 through the opening 195.

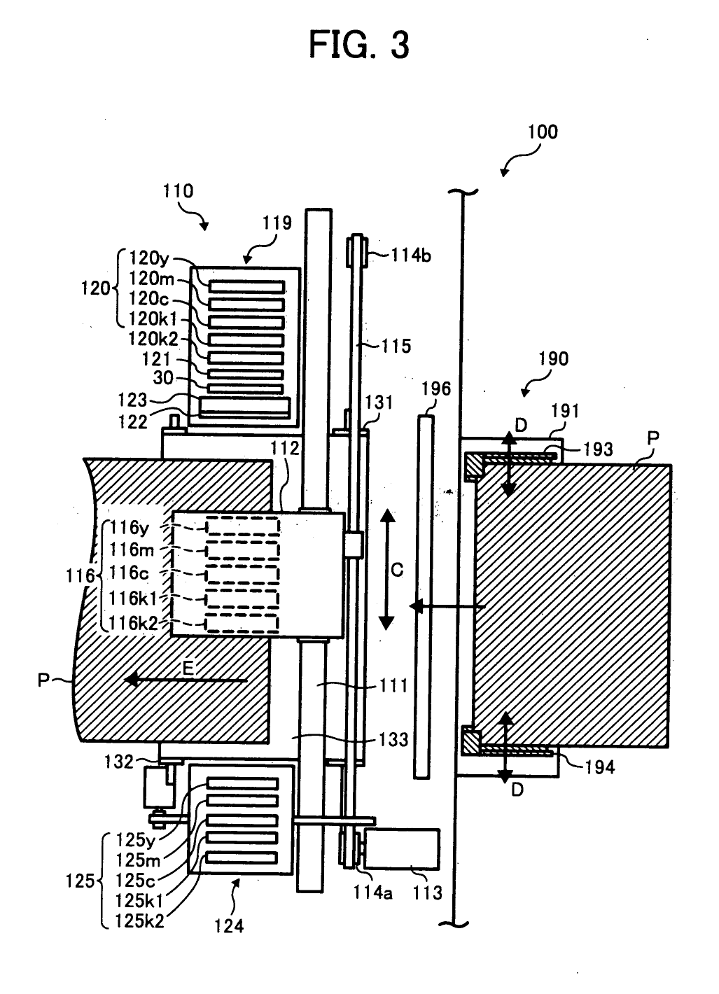

FIG. 3 is a top view of the image forming unit 110 and the bypass sheet supplier 190 of the image forming apparatus 100 (depicted in FIG. 2). As illustrated in FIG. 3, the bypass sheet supplier 190 further includes side fences 193 and 194. The image forming unit 110 further includes a timing belt 115, a main scanning motor 113, a driving pulley 114a, a driven pulley 114b, a maintenance-recovery mechanism 119, and an idle discharge receiver 124. The recording heads 116 include liquid drop discharging heads 116k2, 116k1, 116c, 116m, and 116y. The maintenance-recovery mechanism 119 includes moisture retention caps 120, a sucking cap 121, a suction pump 30, an idle discharge receiver 123, and a wiper blade 122. The moisture retention caps 120 include moisture retention caps 120k2, 120k1, 120c, 120m, and 120y. The idle discharge receiver 124 includes openings 125. The openings 125 include openings 125k2, 125k1, 125c, 125m, and 125y. The side fences 193 and 194 are disposed on the bypass tray 191 and regulate the sheet P in the main scanning direction (i.e., directions C). The side fences 193 and 194 are interlocked via a rack (not shown) and a pinion (not shown) to simultaneously slide in directions D. Specifically, the side fences 193 and 194 simultaneously move closer to each other or simultaneously move away from each other. However, as an alternative, one of the side fences 193 and 194 may be fixed and disposed on the bypass tray 191, and the other may regulate the sheet P to contact or touch the one of the side fences 193 and 194.

The timing belt 115 is looped over the driving pulley 114a and the driven pulley 114b. The main scanning motor 113 drives the driving pulley 114a. The driving pulley 114a rotates the timing belt 115. The rotating timing belt 115 rotates the driven pulley 114b. The rotating timing belt 115 moves the carriage 112 supported by the guide rod 111 and the stay in the main scanning direction (i.e., the directions C).

The recording heads 116 are mounted on the carriage 112 and discharge liquid droplets by a shuttle method. Specifically, while the sheet P is conveyed on the conveying belt 133 rotating in a direction E (i.e., the sub-scanning direction), the recording heads 116 on the carriage 112 moving in the directions C discharge liquid droplets onto the sheet P. However, the recording heads 116 may be configured to discharge liquid droplets by a line method in which the recording heads 116 discharge liquid droplets without moving in the main scanning direction.

The liquid drop discharging heads 116k2 and 116k1 discharge a black ink. The liquid drop discharging heads 116c, 116m, and 116y discharge cyan, magenta, and yellow inks, respectively. The black, cyan, magenta, and yellow inks are supplied from the sub tanks 117 (depicted in FIG. 2).

The sub tanks 117 include five tanks. Two of the five tanks contain a black ink. The other three tanks contain cyan, magenta, and yellow inks, respectively. The ink cartridges 118 (depicted in FIG. 2) include four ink cartridges, respectively, containing black, cyan, magenta, and yellow inks. A black ink is supplied from one ink cartridge containing the black ink to two tanks for containing the black ink. Cyan, magenta, and yellow inks are supplied from the other three ink cartridges containing the cyan, magenta, and yellow inks, respectively, to the other three tanks for containing the cyan, magenta, and yellow inks, respectively.

Multiple types of the recording heads 116, including piezo, thermal, and electrostatic types, can be used. The piezo type recording head uses a piezoelectric element as a pressure generator (e.g., an actuator) for applying a pressure to ink in an ink flow route (e.g., a pressure generating room) to deform a vibration board forming walls of the ink flow route, so that a changed volume of the ink flow route discharges an ink droplet. The thermal type recording head uses a heat generating resistance body to generate a bubble by boiling ink in an ink flow route, so that a pressure of the bubble discharges an ink droplet. The electrostatic type recording head uses a vibration board forming walls of an ink flow route and an electrode, which oppose each other, so that the vibration board deformed by an electrostatic force generated between the vibration board and the electrode changes a volume of the ink flow route and discharges an ink droplet.

The maintenance-recovery mechanism 119 is disposed in a non-printing area, where the recording heads 116 do not discharge an ink droplet, near one end of the guide rod 111 in the main scanning direction. The maintenance-recovery mechanism 119 maintains nozzles of the recording heads 116 and recovers residue ink from the recording heads. The five moisture retention caps 120k2, 120k1, 120c, 120m, and 120y cap nozzles of the recording heads 116k2, 116k1, 116c, 116m, and 116y, respectively. The sucking cap 121 caps a nozzle of the recording heads 116 to suck a liquid droplet. The suction pump 30 is connected to the sucking cap 121 and applies suction to draw a liquid droplet from the nozzle of the recording heads 116. The idle discharge receiver 123 receives a liquid droplet which is discharged during idle discharge and is not used for printing. The wiper blade 122 wipes the nozzles of the recording heads 116.

The idle discharge receiver 124 is disposed in another non-printing area near another end of the guide rod 111 in the main scanning direction. The openings 125 receive liquid droplets which are discharged from the recording heads 116 during idle discharge and are not used for printing. The openings 125k2, 125k1, 125c, 125m, and 125y receive the liquid droplets discharged from the recording heads 116k2, 116k1, 116c, 116m, and 116y, respectively.

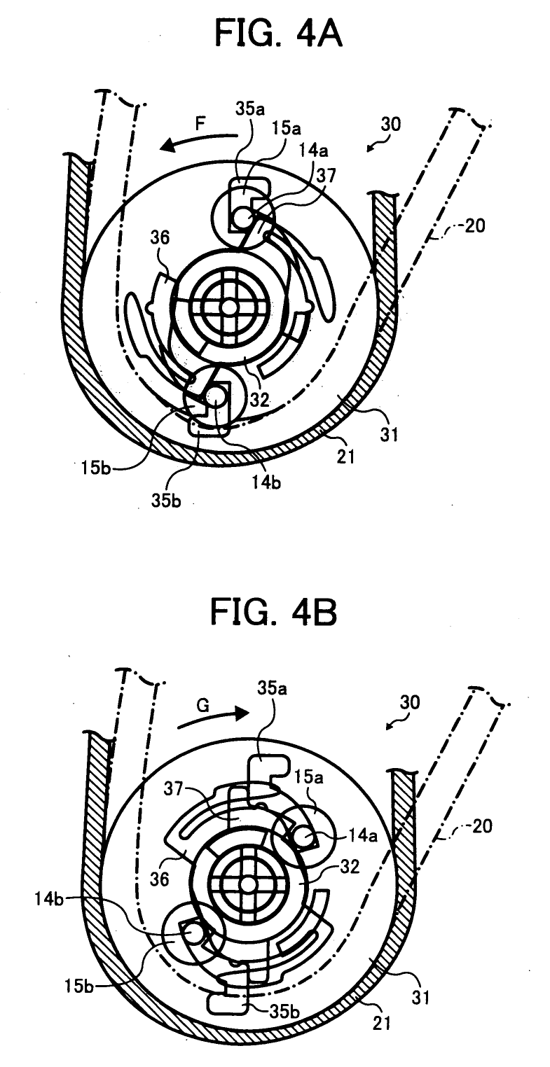

FIGS. 4A and 4B illustrate a perspective plane view of the suction pump 30 (depicted in FIG. 3). As illustrated in FIGS. 4A and 4B, the suction pump 30 includes a tube 20, a housing 21, a rear plate 31, a front plate 36, a regulating plate 37, and pressing rollers 15a and 15b. The rear plate 31 includes a central shaft 32 and grooves 35a and 35b. The pressing rollers 15a and 15b include pressing roller shafts 14a and 14b, respectively.

One end of the tube 20 is connected to the sucking cap 121 (depicted in FIG. 3), which caps the nozzle of the recording heads 116 (depicted in FIG. 3), to suck ink from the nozzle. Another end of the tube 20 is connected to a collected ink container (not shown). The sucked ink is conveyed in the tube 20 and is discharged into the collected ink container. The housing 21 includes an inner wall having an arc-like shape and configured to hold the tube 20. Specifically, the housing 21 holds the tube 20 along its inner wall. The rear plate 31 is disposed behind the front plate 36. The front plate 36 is disposed behind the regulating plate 37. The regulating plate 37 is disposed in front of the front plate 36 and regulates movement of the pressing rollers 15a and 15b in a circumferential direction. The central shaft 32 is disposed on a center of the rear plate 31. The grooves 35a and 35b engage with the pressing roller shafts 14a and 14b, respectively. The pressing rollers 15a and 15b are provided between the rear plate 31 and the front plate 36 and rotatably move along the tube 20 held by the housing 21. The pressing roller shafts 14a and 14b support the pressing rollers 15a and 15b, respectively.

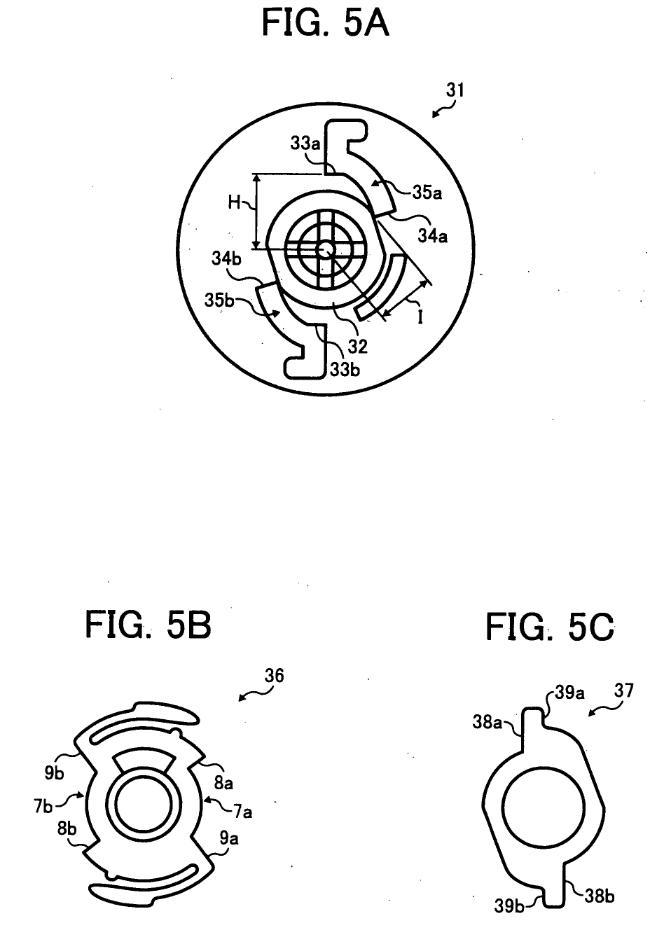

FIG. 5A illustrates the rear plate 31. The groove 35a includes engaging ends 33a and 34a. The groove 35b includes engaging ends 33b and 34b. The engaging end 33a is formed at a pumping position on the groove 35a in a manner that a distance H is provided between the engaging end 33a and the center of the central shaft 32. Similarly, the engaging end 33b is formed at a pumping position on the groove 35b in a manner that the distance H is provided between the engaging end 33b and the center of the central shaft 32. The engaging end 34a is formed at a non-pumping position on the groove 35a in a manner that a distance I is provided between the engaging end 34a and the center of the central shaft 32. Similarly, the engaging end 34b is formed at a non-pumping position on the groove 35b in a manner that the distance I is provided between the engaging end 34b and the center of the central shaft 32. The distance H is greater than the distance I.

FIG. 5B illustrates the front plate 36. The front plate 36 includes guides 7a and 7b. The guide 7a includes engaging ends 8a and 9a. The guide 7b includes engaging ends 8b and 9b. The guides 7a and 7b guide the pressing rollers 15a and 15b (depicted in FIGS. 4A and 4B), respectively. The engaging ends 8a and 8b are provided on one end of the guides 7a and 7b in the circumferential direction, respectively. The engaging ends 9a and 9b are provided on another end of the guides 7a and 7b in the circumferential direction, respectively.

FIG. 5C illustrates the regulating plate 37. The regulating plate 37 includes regulating ends 38a, 38b, 39a, and 39b. The regulating ends 38a and 39a contact the pressing roller shaft 14a (depicted in FIGS. 4A and 4B) to regulate movement of the pressing roller 15a (depicted in FIGS. 4A and 4B). The regulating ends 38b and 39b contact the pressing roller shaft 14b (depicted in FIGS. 4A and 4B) to regulate movement of the pressing roller 15b (depicted in FIGS. 4A and 4B).

Referring to FIGS. 4A and 4B, operations of the suction pump 30 will be further described. As illustrated in FIGS. 4A and 4B, the central shaft 32 rotatably supports the rear plate 31, the front plate 36, and the regulating plate 37. The pressing rollers 15a and 15b are provided between the rear plate 31 and the front plate 36. The grooves 35a and 35b engage with the pressing roller shafts 14a and 14b in a manner that the pressing roller shafts 14a and 14b move in the grooves 35a and 35b so as to guide the pressing rollers 15aand 15b, respectively.

As illustrated in FIG. 4A, when a motor (not shown) rotates the rear plate 31, the front plate 36, and the regulating plate 37 in a rotating direction F to perform a pumping operation, the pressing roller shaft 14a moves towards the engaging end 33a (depicted in FIG. 5A) along the groove 35a (depicted in FIG. 5A) provided on the rear plate 31 (depicted in FIG. 5A) and along the guide 7a (depicted in FIG. 5B) provided on the front plate 36 (depicted in FIG. 5B). The pressing roller shaft 14b moves towards the engaging end 33b (depicted in FIG. 5A) along the groove 35b (depicted in FIG. 5A) provided on the rear plate 31 (depicted in FIG. 5A) and along the guide 7b (depicted in FIG. 5B) provided on the front plate 36 (depicted in FIG. . 5B). The regulating ends 38a and 38b (depicted in FIG. 5C) contact the pressing roller shafts 14a and 14b to keep the pressing roller shafts 14a and 14b to contact the engaging ends 33a and 33b (depicted in FIG. 5A), respectively. Thus, the pressing roller shafts 14a and 14b keep contacting the engaging ends 33a and 33b, respectively. When the rear plate 31, the front plate 36, and the regulating plate 37 further rotate in the rotating direction F while the pressing roller shafts 14a and 14b contact the engaging ends 33a and 33b, respectively, the pressing rollers 15a and 15b alternately press the tube 20 towards the inner wall of the housing 21 while the pressing rollers 15a and 15b move along the tube 20. Namely, the pressing rollers 15a and 15b apply a positive pressure to the tube 20. When the rear plate 31, the front plate 36, and the regulating plate 37 further rotate in the rotating direction F while the pressing roller shafts 14a and 14b contact the engaging ends 33a and 33b, respectively, the pressing rollers 15a and 15b alternately move away from the tube 20 and the pressure applied to the tube 20 is released. Namely, the pressing rollers 15a and 15b apply a negative pressure to the tube 20. Thus, a pumping operation is performed and ink is drawn by suction into the tube 20.

As illustrated in FIG. 4B, when the rear plate 31, the front plate 36, and the regulating plate 37 rotate in a rotating direction G (i.e., a direction opposite to the rotating direction F) to stop the pumping operation, the pressing roller shaft 14a moves along the groove 35a and the guide 7a (depicted in FIG. 5B) towards the engaging end 34a (depicted in FIG. 5A). The pressing roller shaft 14b moves along the groove 35b and the guide 7b (depicted in FIG. 5B) towards the engaging end 34b (depicted in FIG. 5A). Thus, the pressing roller shafts 14a and 14b contact the engaging ends 34a and 34b, respectively. The regulating ends 39a and 39b (depicted in FIG. 5C) contact the pressing roller shafts 14a and 14b to keep the pressing roller shafts 14a and 14b to contact the engaging ends 34a and 34b, respectively. As a result, the pressing rollers 15a and 15b do not contact the tube 20. Namely, the pressing rollers 15a and 15b do not apply a pressure to the tube 20. Thus, a pumping operation is not performed.

When the rear plate 31, the front plate 36, and the regulating plate 37 rotate in the rotating direction F while the pressing roller shafts 14a and 14b contact the engaging ends 33a and 33b, respectively (i.e., while the pressing rollers 15a and 15b are at a pumping position), the pressing rollers 15a and 15b press the tube 20 when the pressing rollers 15a and 15b move along the tube 20. Namely, the pressing rollers 15a and 15b apply a positive pressure to the tube 20. When the rear plate 31, the front plate 36, and the regulating plate 37 rotate in the rotating direction G while the pressing roller shafts 14a and 14b contact the engaging ends 34a and 34b, respectively (i.e., while the pressing rollers 15a and 15b are at a non-pumping position), the pressing rollers 15a and 15b do not contact the tube 20 while the pressing rollers 15a and 15b move along the tube 20, and thereby do not press the tube 20. Namely, the pressing rollers 15a and 15b apply a negative pressure to the tube 20. Thus, ink is drawn by suction through one end of the tube 20 from a nozzle of the recording heads 116 (depicted in FIG. 3) and is discharged into a collected ink container (not shown) through another end of the tube 20.

As described above, in the suction pump 30 in the embodiment of FIGS. 4A and 4B, the regulating plate 37 holds each of the pressing rollers 15a and 15b at a predetermined position (i.e., the pumping or non-pumping position) in the circumferential direction defined for each of pumping and non-pumping operations. Namely, each of the pressing rollers 15a and 15b does not move to a position other than the predetermined position defined for each of pumping and non-pumping operations. As a result, pumping and non-pumping operations can be performed with improved reliability.

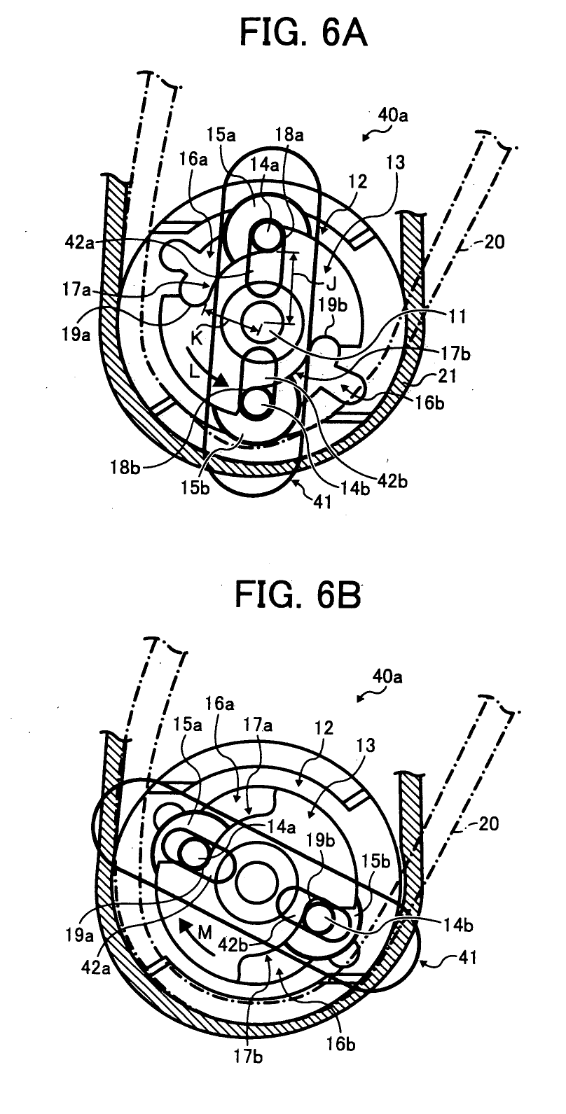

FIGS. 6A and 6B illustrate a perspective plane view of a suction pump 40a according to another exemplary embodiment. The same reference numerals are assigned to the elements common to the suction pump 30 in the embodiment of FIGS. 4A and 4B. As illustrated in FIGS. 6A and 6B, the suction pump 40a includes a rear plate 12, a front plate 13, a regulating plate 41, the pressing rollers 15a and 15b, the housing 21, and the tube 20. The rear plate 12 includes a central shaft 11 and grooves 16a and 16b. The front plate 13 includes guides 17a and 17b. The guide 17a includes engaging ends 18a and 19a. The guide 17b includes engaging ends 18b and 19b. The regulating plate 41 includes grooves 42a and 42b. The pressing rollers 15a and 15b include the pressing roller shafts 14a and 14b, respectively.

The rear plate 12 is disposed behind the front plate 13. The front plate 13 is disposed behind the regulating plate 41. The regulating plate 41 is disposed in front of the front plate 13 and regulates movement of the pressing rollers 15a and 15b in a circumferential direction. The pressing rollers 15a and 15b are provided between the rear plate 12 and the front plate 13 and rotatably move along the tube 20 held by the housing 21. The central shaft 11 rotatably supports the rear plate 12, the front plate 13, and the regulating plate 41. The pressing roller shafts 14a and 14b support the pressing rollers 15a and 15b, respectively. The grooves 16a and 16b engage with the pressing roller shafts 14a and 14b in a manner that the pressing roller shafts 14a and 14b move in the grooves 16a and 16b so as to guide the pressing rollers 15a and 15b, respectively. The guides 17a and 17b guide the pressing rollers 15a and 15b, respectively. The engaging ends 18a and 18b are provided on one end of the guides 17a and 17b in the circumferential direction, respectively. The engaging ends 19a and 19b are provided on another end of the guides 17a and 17b in the circumferential direction, respectively. The grooves 42a and 42b are provided on the regulating plate 41 and engage with the pressing roller shafts 14a and 14b, respectively. The grooves 42a and 42b guide the pressing roller shafts 14a and 14b to regulate movement of the pressing rollers 15a and 15b in the circumferential direction, respectively.

The engaging end 18a is formed at a pumping position on the groove 16a in a manner that a distance J is provided between the engaging end 18a and the center of the central shaft 11. Similarly, the engaging end 18b is formed at a pumping position on the groove 16b in a manner that the distance J is provided between the engaging end 18b and the center of the central shaft 11. The engaging end 19a is formed at a non-pumping position on the groove 16a in a manner that a distance K is provided between the engaging end 19a and the center of the central shaft 11. Similarly, the engaging end 19b is formed at a non-pumping position on the groove 16b in a manner that the distance K is provided between the engaging end 19b and the center of the central shaft 11. The distance J is greater than the distance K.

As illustrated in FIG. 6A, when a motor (not shown) rotates the rear plate 12, the front plate 13, and the regulating plate 41 in a rotating direction L to perform a pumping operation, the pressing roller shaft 14a moves towards the engaging end 18a along the groove 16a provided on the rear plate 12 and along the guide 17a provided on the front plate 13. The pressing roller shaft 14b moves towards the engaging end 18b along the groove 16b provided on the rear plate 12 and along the guide 17b provided on the front plate 13. Thus, the pressing roller shafts 14a and 14b contact the engaging ends 18a and 18b, respectively. The grooves 42a and 42b guide the pressing roller shafts 14a and 14b to regulate movement of the pressing rollers 15a and 15b in the circumferential direction, respectively. When the rear plate 12, the front plate 13, and the regulating plate 41 further rotate in the rotating direction L while the pressing roller shafts 14a and 14b contact the engaging ends 18a and 18b, respectively (i.e., while the pressing rollers 15a and 15b are at the pumping position), the pressing rollers 15a and 15b alternately press the tube 20 towards the inner wall of the housing 21 while the pressing rollers 15a and 15b move along the tube 20. Namely, the pressing rollers 15a and 15b apply a positive pressure to the tube 20. When the rear plate 12, the front plate 13, and the regulating plate 41 further rotate in the rotating direction L while the pressing roller shafts 14a and 14b contact the engaging ends 18a and 18b, respectively, the pressing rollers 15a and 15b alternately move away from the tube 20 and the pressure applied to the tube 20 is released. Namely, the pressing rollers 15a and 15b apply a negative pressure to the tube 20. Thus, a pumping operation is performed and ink is drawn by suction into the tube 20.

As illustrated in FIG. 6B, when the rear plate 12, the front plate 13, and the regulating plate 41 rotate in a rotating direction M (i.e., a direction opposite to the rotating direction L) to stop the pumping operation, the pressing roller shaft 14a moves along the groove 16a and the guide 17a towards the engaging end 19a. The pressing roller shaft 14b moves along the groove 16b and the guide 17b towards the engaging end 19b. The grooves 42a and 42b guide the pressing roller shafts 14a and 14b to regulate movement of the pressing rollers 15a and 15b in the circumferential direction, respectively. Thus, the pressing roller shafts 14a and 14b contact the engaging ends 19a and 19b respectively (i.e., the pressing rollers 15a and 15b are at the non-pumping position) and thereby the pressing rollers 15a and 15b do not contact the tube 20. Namely, the pressing rollers 15a and 15b do not apply a pressure to the tube 20. Thus, a pumping operation is not performed.

As described above, in the suction pump 40a in the embodiment of FIGS. 6A and 6B, the regulating plate 41 holds each of the pressing rollers 15a and 15b at a predetermined position (i.e., the pumping or non-pumping position) in the circumferential direction defined for each of pumping and non-pumping operations. The central shaft 11 rotatably supports the regulating plate 41. Thus, neither of the pressing rollers 15a and 15b moves to a position other than the predetermined position defined for each of pumping and non-pumping operations. As a result, pumping and non-pumping operations can be performed with improved reliability.

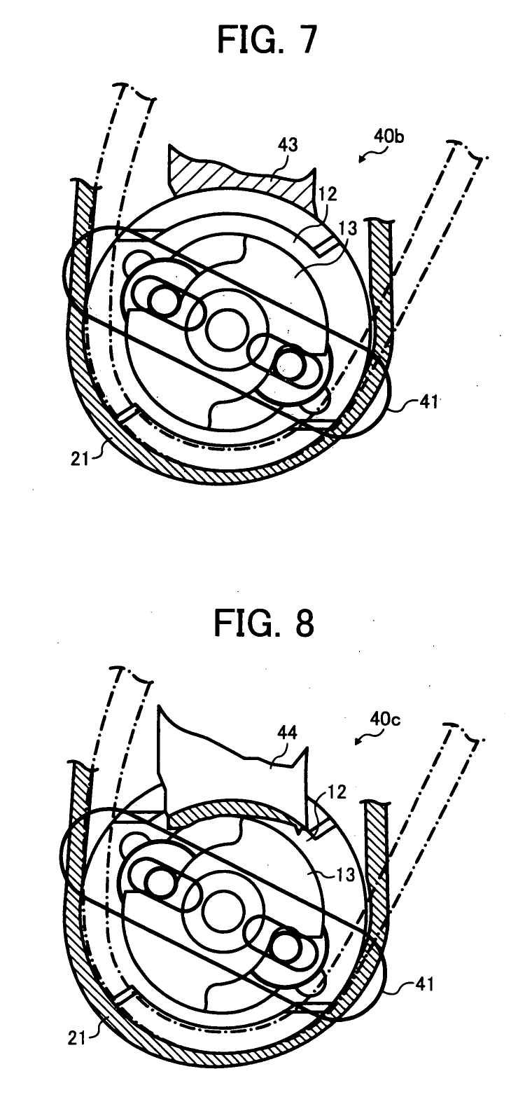

FIG. 7 is a perspective plane view of a suction pump 40b according to another exemplary embodiment. As illustrated in FIG. 7, the suction pump 40b includes the elements common to the suction pump 40a in the embodiment of FIGS. 6A and 6B, but further includes a rotation suppressor 43.

The rotation suppressor 43 contacts an outer plane surface of the rear plate 12 and/or the front plate 13 and suppresses rotation of the rear plate 12 and/or the front plate 13 by friction. The rotation suppressor 43 includes a viscoelastic material and may be attached to the housing 21, for example.

In the suction pump 40b in the embodiment of FIG. 7, the rotation suppressor 43, which suppresses rotation of the rear plate 12 and/or the front plate 13, causes the regulating plate 41 to start rotating earlier than at least one of the rear plate 12 and the front plate 13. As a result, the suction pump 40b can provide improved reliability.

FIG. 8 is a perspective plane view of a suction pump 40c according to another exemplary embodiment. As illustrated in FIG. 8, the suction pump 40c includes the elements common to the suction pump 40a in the embodiment of FIGS. 6A and 6B, but further includes a rotation suppressor 44.

The rotation suppressor 44 contacts an inner plane surface of the rear plate 12 and/or the front plate 13 and suppresses rotation of the rear plate 12 and/or the front plate 13 by friction. The rotation suppressor 44 includes a viscoelastic material and may be attached to the housing 21, for example.

In the suction pump 40c in the embodiment of FIG. 8, the rotation suppressor 44, which suppresses rotation of the rear plate 12 and/or the front plate 13, causes the regulating plate 41 to start rotating earlier than at least one of the rear plate 12 and the front plate 13. As a result, the suction pump 40c can provide improved reliability.

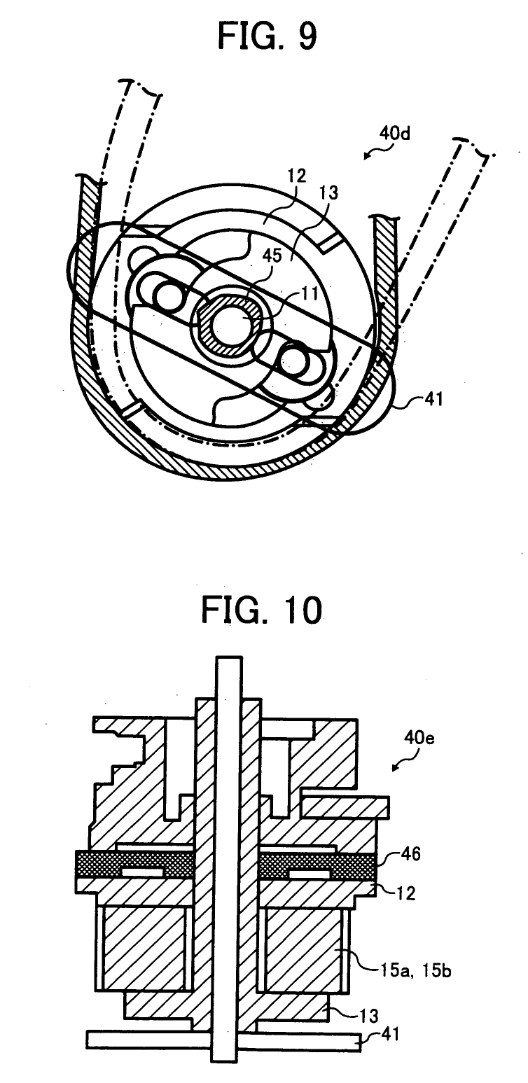

FIG. 9 is a perspective plane view of a suction pump 40d according to another exemplary embodiment. As illustrated in FIG. 9, the suction pump 40d includes the elements common to the suction pump 40a in the embodiment of FIGS. 6A and 6B, but further includes a rotation suppressor 45.

The rotation suppressor 45 is disposed between the central shaft 11 and the rear plate 12 and/or the front plate 13 in a manner that the rotation suppressor 45 contacts the central shaft 11. Thus, the rotation suppressor 45 suppresses rotation of the rear plate 12 and/or the front plate 13 by friction. The rotation suppressor 45 includes a viscoelastic material.

In the suction pump 40d in the embodiment of FIG. 9, the rotation suppressor 45, which suppresses rotation of the rear plate 12 and/or the front plate 13, causes the regulating plate 41 to start rotating earlier than at least one of the rear plate 12 and the front plate 13. As a result, the suction pump 40d can provide improved reliability.

FIG. 10 is a sectional side view of a suction pump 40e according to another exemplary embodiment. As illustrated in FIG. 10, the suction pump 40e includes the elements common to the suction pump 40a in the embodiment of FIGS. 6A and 6B, but further includes a rotation suppressor 46.

The rotation suppressor 46 contacts a plane surface of the rear plate 12 and suppresses rotation of the rear plate 12 by friction. The rotation suppressor 46 includes a viscoelastic material. The rotation suppressor 46 may contact a plane surface of the front plate 13 so as to suppress rotation of the front plate 13.

In the suction pump 40e in the embodiment of FIG. 10, the rotation suppressor 46, which suppresses rotation of the rear plate 12 or the front plate 13, causes the regulating plate 41 to start rotating earlier than at least one of the rear plate 12 and the front plate 13. As a result, the suction pump 40e can provide improved reliability.

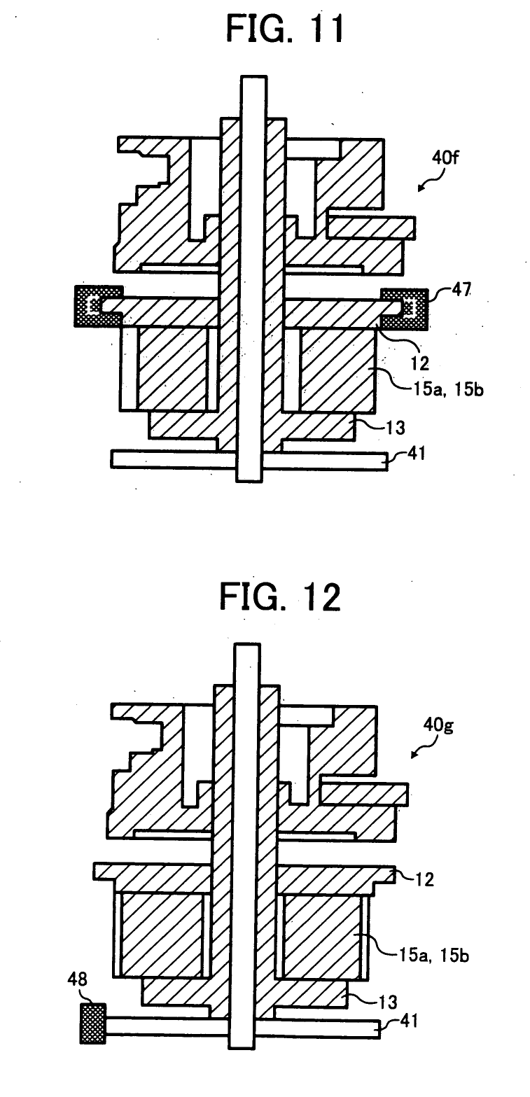

FIG. 11 is a sectional side view of a suction pump 40f according to another exemplary embodiment. As illustrated in FIG. 11, the suction pump 40f includes the elements common to the suction pump 40a in the embodiment of FIGS. 6A and 6B, but further includes a case 47.

The case 47 contacts and covers an outer circumferential edge of the rear plate 12 and suppresses rotation of the rear plate 12 by friction caused between the case 47 and the housing 21 (depicted in FIGS. 6A and 6B), for example. The case 47 includes a viscoelastic material such as silicone oil. A viscoelastic force of the viscoelastic material suppresses rotation of the rear plate 12. The case 47 may contact and cover an outer circumferential edge of the front plate 13 so as to suppress rotation of the front plate 13.

In the suction pump 40f in the embodiment of FIG. 11, the case 47, which suppresses rotation of the rear plate 12 or the front plate 13, causes the regulating plate 41 to start rotating earlier than at least one of the rear plate 12 and the front plate 13. As a result, the suction pump 40f can provide improved reliability.

FIG. 12 is a sectional side view of a suction pump 40g according to another exemplary embodiment. As illustrated in FIG. 12, the suction pump 40g includes the elements common to the suction pump 40a in the embodiment of FIGS. 6A and 6B, but further includes a rotation suppressor 48.

The rotation suppressor 48 contacts an outer circumferential edge of the regulating plate 41 and suppresses rotation of the regulating plate 41 by friction caused between the rotation suppressor 48 and the housing 21 (depicted in FIGS. 6A and 6B), for example. The rotation suppressor 48 includes a viscoelastic material.

In the suction pump 40g in the embodiment of FIG. 12, the rotation suppressor 48, which suppresses rotation of the regulating plate 41, causes the rear plate 12 and the front plate 13 to start rotating earlier than the regulating plate 41. As a result, the suction pump 40g can provide improved reliability.

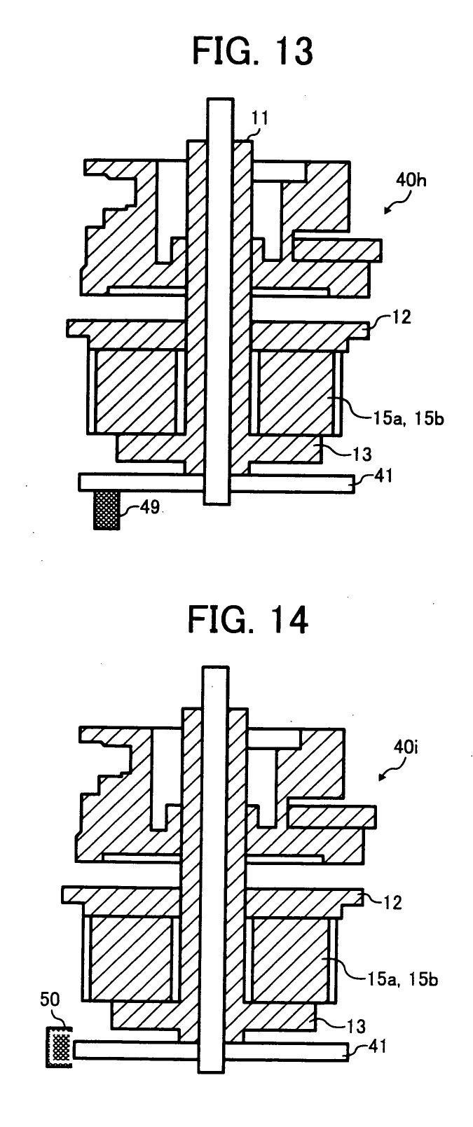

FIG. 13 is a sectional side view of a suction pump 40h according to another exemplary embodiment. As illustrated in FIG. 13, the suction pump 40h includes the elements common to the suction pump 40a in the embodiment of FIGS. 6A and 6B, but further includes a rotation suppressor 49.

The rotation suppressor 49 contacts a plane surface of the regulating plate 41 and suppresses rotation of the regulating plate 41 by friction caused between the rotation suppressor 49 and the housing 21 (depicted in FIGS. 6A and 6B), for example. The rotation suppressor 49 includes a viscoelastic material. To further suppress rotation of the regulating plate 41, a rib may be formed on the plane surface of the regulating plate 41 in a manner that the rib forms a concentric circle in which the central shaft 11 is the center.

In the suction pump 40h in the embodiment of FIG. 13, the rotation suppressor 49, which suppresses rotation of the regulating plate 41, causes the rear plate 12 and the front plate 13 to start rotating earlier than the regulating plate 41. As a result, the suction pump 40h can provide improved reliability.

FIG. 14 is a sectional side view of a suction pump 40i according to another exemplary embodiment. As illustrated in FIG. 14, the suction pump 40i includes the elements common to the suction pump 40a in the embodiment of FIGS. 6A and 6B, but further includes a case 50.

The case 50 contacts an outer circumferential edge of the regulating plate 41 and suppresses rotation of the regulating plate 41 by friction caused between the case 50 and the housing 21 (depicted in FIGS. 6A and 6B), for example. The case 50 includes a viscoelastic material such as silicone oil. A viscoelastic force of the viscoelastic material suppresses rotation of the regulating plate 41.

In the suction pump 40i in the embodiment of FIG. 14, the case 50, which suppresses rotation of the regulating plate 41, causes the rear plate 12 and the front plate 13 to start rotating earlier than the regulating plate 41. As a result, the suction pump 40i can provide improved reliability.

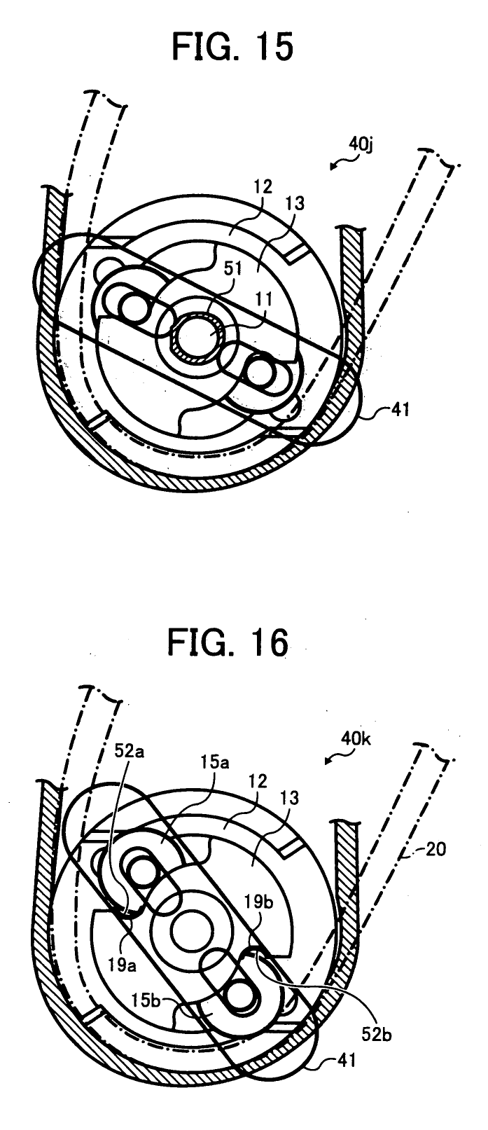

FIG. 15 is a perspective plane view of a suction pump 40j according to another exemplary embodiment. As illustrated in FIG. 15, the suction pump 40j includes the elements common to the suction pump 40a in the embodiment of FIGS. 6A and 6B, but further includes a rotation suppressor 51.

The rotation suppressor 51 is disposed between the central shaft 11 and the regulating plate 41 in a manner that the rotation suppressor 51 contacts the central shaft 11, and suppresses rotation of the regulating plate 41 by friction. The rotation suppressor 51 includes a viscoelastic material.

In the suction pump 40j in the embodiment of FIG. 15, the rotation suppressor 51, which suppresses rotation of the regulating plate 41, causes the rear plate 12 and the front plate 13 to start rotating earlier than the regulating plate 41. As a result, the suction pump 40j can provide improved reliability.

FIG. 16 is a perspective plane view of a suction pump 40k according to another exemplary embodiment. As illustrated in FIG. 16, the suction pump 40k includes the elements common to the suction pump 40a in the embodiment of FIGS. 6A and 6B, but further includes impact absorbers 52a and 52b.

The impact absorbers 52a and 52b are disposed on the engaging ends 19a and 19b, respectively. When the pressing rollers 15a and 15b pressing the tube 20 alternately move away from the tube 20 while the suction pump 40k performs a pumping operation, an elastic force of the tube 20 bounces the pressing rollers 15a and 15b. The bounced pressing rollers 15a and 15b hit the engaging ends 19a and 19b, respectively, and generate an impulsive sound. The impact absorbers 52a and 52b relieve an impact caused by the bounced pressing rollers 15a and 15b.

In the suction pump 40k in the embodiment of FIG. 16, the impact absorbers 52a and 52b relieve an impact caused by the bounced pressing rollers 15a and 15b to suppress an impulsive sound caused by the pressing rollers 15a and 15b hitting the engaging ends 19a and 19b, respectively. As a result, the suction pump 40k can provide improved reliability.

Instead of providing the impact absorbers 52a and 52b, the elements included in the rear plate 12 and the front plate 13, a portion of the rear plate 12 and/or the front plate 13 contacting the pressing roller shafts 14a and 14b (depicted in FIGS. 6A and 6B) and/or the pressing rollers 15a and 15b, the pressing roller shafts 14a and 14b, and/or the pressing rollers 15a and 15b may include a material having a low degree of hardness, gin content, or elasticity, such as an elastomer and/or a resin containing an elastomer.

Numerous additional modifications and variations are possible in light of the above teachings. It is therefore to be understood that within the scope of the appended claims, the disclosure of this patent specification may be practiced otherwise than as specifically described herein. For example, elements and/or features of different illustrative embodiments may be combined with each other and/or substituted for each other within the scope of this disclosure and appended claims.

This patent specification is based on Japanese patent application No. 2005-338368 filed on Nov. 24, 2005 in the Japan Patent Office, the entire contents of which are hereby incorporated herein by reference.

What is claimed is:

1. An image forming apparatus, comprising:
a recording head configured to discharge a liquid onto a recording medium; and
a maintenance-recovery mechanism including:
a cap configured to cap the recording head: and
a suction pump configured to apply suction to draw a liquid from the recording head through the cap and including
a tube connected to the cap and configured to channel the liquid drawn through the cap and one end of the tube by said suction pump, and discharge the liquid at another end of the tube,
a housing including an inner wall having an arc-like shape, the inner wall holding the tube along the inner wall,
a pressing member configured to move along the tube, and including a shaft provided at a center of the pressing member,
a rotating member configured to rotate to move the pressing member and including a groove engaged with the shaft of the pressing member to guide the pressing member between a first position at which the pressing member presses the tube towards the inner wall of the housing while the pressing member moves along the tube and a second position at which the pressing member does not press the tube, and
a regulating member configured to coaxially rotate with the rotating member to regulate movement of the pressing member in a circumferential direction.

2. The image forming apparatus according to claim 1,
wherein the pressing member applies a positive pressure to the tube when the pressing member presses the tube and a negative pressure to the tube when the pressing member does not press the tube.

3. The image forming apparatus according to claim 1,
wherein the regulating member starts rotating earlier than the rotating member.

4. The image forming apparatus according to claim 1,
wherein the suction pump further includes a rotation suppressor configured to suppress rotation of the rotating member.

5. The image forming apparatus according to claim 4,
wherein the rotation suppressor suppresses rotation of the rotating member by contacting an outer circumferential edge of the rotating member.

6. The image forming apparatus according to claim 4,
wherein the rotating member further includes a shaft, and
wherein the rotation suppressor suppresses rotation of the rotating member by contacting the shaft.

7. The image forming apparatus according to claim 4,
wherein the rotating member has a plane, and
wherein the rotation suppressor suppresses rotation of the rotating member by contacting the plane surface of the rotating member.

8. The image forming apparatus according to claim 1,
wherein the rotating member starts rotating earlier than the regulating member.

9. The image forming apparatus according to claim 1,
wherein the suction pump further includes a rotation suppressor configured to suppress rotation of the regulating member.

10. The image forming apparatus according to claim 9,
wherein the rotation suppressor suppresses rotation of the regulating member by contacting an outer circumferential edge of the regulating member.

11. The image forming apparatus according to claim 9,
wherein the regulating member includes a shaft, and
wherein the rotation suppressor suppresses rotation of the regulating member by contacting the shaft.

12. The image forming apparatus according to claim 9,
wherein the regulating member has a plane, and
wherein the rotation suppressor suppresses rotation of the regulating member by contacting the plane surface of the regulating member.

13. The image forming apparatus according to claim 1,
wherein the suction pump further includes an impact absorber configured to relieve an impact caused by the pressing member hitting the groove at the second position.

14. The image forming apparatus according to claim 13,
wherein the rotating member also serves as the impact absorber.

15. The image forming apparatus according to claim 13,
wherein the impact absorber is disposed at the second position.

16. A maintenance-recovery mechanism for maintaining and recovering a recording head of an image forming apparatus, comprising:
a cap configured to cap the recording head; and
a suction pump configured to apply suction to draw a liquid from the recording head through the cap and including,
a tube connected at one end of the tube to the cap and configured to channel the liquid drawn through the cap and said one end of the tube by the suction pump, and to discharge the liquid at another end of the tube,
a housing including an inner wall having an arc-like shape, the inner wall holding the tube along the inner wall,
a pressing member configured to move along the tube, and including a shaft provided at a center of the pressing member,
a rotating member configured to rotate to move the pressing member and including a groove engaged with the shaft of the pressing member to guide the pressing member between a first position at which the pressing member presses the tube towards the inner wall of the housing while the pressing member moves along the tube and a second position at which the pressing member does not press the tube, and
a regulating member configured to coaxially rotate with the rotating member to regulate movement of the pressing member in a circumferential direction.

17. A suction pump for applying suction to draw a liquid from a recording head of an image forming apparatus, comprising:
a tube connected at one end of the tube to the recording head and configured to channel the liquid drawn through said one end of the tube from the recording head by the application of the suction, and discharge the liquid at another end of the tube;
a housing including an inner wall having an arc-like shape, the inner wall holding the tube along the inner wall;
a pressing member configured to move along the tube, and including a shaft provided at a center of the pressing member;
a rotating member configured to rotate to move the pressing member and including a groove engaged with the shaft of the pressing member to guide the pressing member between a first position at which the pressing member presses the tube towards the inner wall of the housing while the pressing member moves along the tube and a second position at which the pressing member does not press the tube; and
a regulating member configured to coaxially rotate with the rotating member to regulate movement of the pressing member in a circumferential direction.
